(19) United States
(12) Patent Application Publication
(10) Pub. No.: US 2005/0129149 A1
(43) Pub. Date: Jun. 16, 2005

(54) Detecting GSM downlink signal frequency correction burst

(76) Inventor: Thomas L. Kuntz, Portland, OR (US)

Correspondence Address: TEKTRONIX, INC.;Francis I. Gray, MS 50-LAW, P.O. Box 500, Beaverton, OR, 97077, US

(21) Appl. No.: 10/734,407

(22) Filed: Dec. 12, 2003

(51) Int. Cl. H04L 27/06

(52) U.S. Cl. 375/343

(57) ABSTRACT

A method of detecting in a GSM downlink signal a frequency correction burst signal uses a correlation technique that is insensitive to the amount of frequency offset from a nominal carrier frequency. Instead of using a constant reference vector as a reference signal, a delayed version of the downlink signal itself is used as the reference signal with the time delay set to a period that ideally causes the delayed version to overlay the current version of the signal, such as an integer multiple of four times the symbol period for a GSM downlink signal. Then the correlation result produces a maximum correlation magnitude to detect the FCB signal that is insensitive to any frequency offset. The resulting correlation vector phase angle may then be used to estimate the frequency offset in the GSM downlink carrier frequency. Further for small frequency offsets a variation may be implemented that uses only the real components of the correlation product to improve computational efficiency.

### BACKGROUND OF THE INVENTION

The present invention relates to telecommunications measurements, and more particularly to a method of detecting a frequency correction burst signal in a received downlink signal such as a GSM downlink signal.

A GSM downlink signal uses Time Division Multiplexing (TDM) techniques to convey signal information to multiple users on a single Radio Frequency (RF) carrier. The TDM technique uses frames and time slots to subdivide a transmitted waveform into time intervals during which the signal carries general system information or user-specific information. For a TDM system such as the GSM system, the first slot in each frame contains frame synchronization information, with every tenth frame having a Frequency Correction Burst (FCB) signal as the frame synchronization information. Each time slot represents 148 “symbols” or data words. In order for a user to access the system, mobile hardware must first obtain synchronization to the time frame structure of the TDM system by detecting and decoding special synchronization bursts in fixed locations in the signal, such as the FCB signal. Once the mobile hardware has acquired frame synchronization, it may access the TDM system to use voice or data services.

A measuring device, such as a test instrument, may also use the synchronization information to acquire frame synchronization with a GSM downlink signal. When synchronized to the frame structure, the measuring device may make measurements on specific time slot intervals of the signal. This capability is of interest to network operators, especially with the introduction of new data services including enhanced modes such as EDGE (Enhanced Data for GSM Evolution). Operators are concerned to measure time slots where the enhanced signal modulation, called 8PSK (Phase Shift Keying), is used. Frame synchronization allows the measuring device user to specify particular time slots for measurement.

Detecting the FCB signal is a first step in detecting the frame structure of a GSM downlink signal. The FCB signal consists of a single Continuous-Wave (CW) tone transmitted at a frequency 270833/4=67708 Hz above the nominal carrier frequency of the downlink signal. The tone is transmitted for 148 symbol intervals in the first time slot of every tenth frame, equivalent to 148/270833=546.4 microseconds. The FCB signal may be described mathematically as:
s(t)=A cos(ωt+φ0) 0≦t≦546.4 μsec
where:
A=amplitude of the CW waveform
ω=radian frequency of the CW tone at RF=2π*(F_{carrier}+F_{symbol}/4+F_{offset})
φ0=initial phase of the CW tone and
F_{carrier}=the nominal GSM signal carrier center frequency
F_{symbol}=GSM symbol rate=270833 Hz
F_{offset}=unknown frequency offset between the transmitter and receiver
   For ease of analysis the signal may be described at baseband (0->IF) using complex phasor notation:
   s(t)=A exp([j(ω′t+φ0)]0≦t≦546.4 μsec
   where:
A=amplitude of the complex waveform
ω′=radian frequency of the tone at baseband=2π*(F_{symbol}/4+F_{offset})
φ0=initial phase of the tone Analysis could be continued on the continuous form of the signal. However it is convenient to switch to a discrete-time sampled version of the signal by substituting t=n*Tₛₐₘₚₗₑ=n/Fₛₐₘₚₗₑ:
   s(n)=A exp[(ω′/Fₛₐₘₚₗₑ*n+ω0)]0≦n≦N=147*(F_{sample/F}_{symbol})

Because ostensibly only the FCB signal is correlated within a time slot, correlation techniques have been used to attempt to detect the FCB signal. One method of detecting the presence of the FCB signal is to perform a correlation of the received signal with a conjugate version of the ideal FCB signal and find the location of the largest correlation magnitude “peak”. The ideal FCB signal is one with no frequency offset (F_{offset}=0) and initial phase of 0, and may be described as:
r(n)=exp[j(2π*F_{symbol}/4)/Fₛₐₘₚₗₑ*n]
Then the correlation result when exactly aligned with the FCB signal is:

$$\begin{matrix}R = {\sum }_{n = 0 -> N}^{} s ( n ) * conj [ r ( n ) ] \\ = {\sum }_{n = 0 -> N}^{} A exp [ j ( 2 π ( {F}_{symbol} / 4 + {F}_{offset} ) / {F}_{sample} * n + φ 0 ) ] * \\ exp [ - j 2 π ( {F}_{symbol} / 4 ) / {F}_{sample } * n ] \\ = A {\sum }_{n = 0 -> N}^{} exp [ j ( 2 π ( {F}_{symbol} / 4 + {F}_{offset} - {F}_{offset} / 4 ) / \\ {F}_{sample} * n + φ 0 ) ] \\ = A {\sum }_{n = 0 -> N}^{} exp [ j ( 2 π {F}_{offset} // {F}_{sample} * n + φ 0 ) ]\end{matrix}$$

The problem with this result is that the correlation magnitude varies depending on the value of F_{offset}. FIG. 1 shows constellation points at 4-symbol spaced instances with a significant frequency offset, where Ref is the reference vector used in the above correlation method. Note that Ref is fixed and does not rotate with the actual signal constellation vector over time. If F_{offset}=0, the |R| achieves its maximum possible value when exactly aligned with the received FCB signal. However if F_{offset}=1829 Hz (dP), then the angular rotation of the phasor as shown in FIG. 2 produces a completely destructive summation over the summation interval, producing a very small correlation magnitude and likely causing FCB signal detection failure. As shown the fixed Ref does not compensate for the incremental phase rotation dP due to the frequency offset. As a result the correlation vector R has a smaller magnitude than the sum of the individual vector magnitudes. This happens because the differing phase angles of the vectors cause some cancellation in the correlation summation. Integer multiples of this frequency offset produce the same effect. Even values of F_{offset} much less than 1829 Hz degrade the maximum correlation magnitude value. Additionally correlation with the fixed Ref may result in correlation peaks at other points in the GSM signal that could give false FCB signal locations.

Another method for detecting the FCB signal is shown in U.S. Pat. No. 6,226,336 issued May 1, 2001 to Roozbeh Atarious et al entitled “Method and Apparatus for Detecting a Frequency Synchronization Signal, where the normalized I and Q components of each symbol are multiplied together after the normalized I component is delayed by one symbol interval. This process is repeated for a predetermined number of samples of the received signal, i.e., one time slot of 148 symbols, to produce an estimated cross-correlation value which is compared with a predetermined threshold to detect the FCB signal. However this system also is prone to errors in detecting the location of the FCB signal.

What is desired is a method of detecting in the GSM downlink signal, or other TDM-type signal, an FCB signal which is very insensitive to offset of the RF carrier frequency from an assumed nominal frequency, and is robust in detecting the FCB signal when the transmitter and receiver oscillators are not closely aligned in frequency.

### BRIEF SUMMARY OF THE INVENTION

Accordingly the present invention provides a method of detecting in a GSM downlink signal a frequency correction burst (FCB) signal using a correlation technique that is insensitive to the amount of frequency offset from a nominal carrier frequency. Instead of using a constant reference vector as a reference waveform, a delayed version of the signal itself is used as the reference waveform with the time delay set to a period that ideally causes the delayed version to overlay the current version of the signal, such as an integer multiple of four times the symbol period for a GSM downlink signal. Then the correlation result produces a maximum correlation magnitude to detect the FCB signal that is insensitive to any frequency offset up to one-half of the symbol rate (270833/2=135416). The resulting correlation vector phase angle may then be used to estimate the frequency offset of the signal carrier. Further for small frequency offsets a variation may be implemented that uses only the real components of the correlation product to improve computational efficiency.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a graphic view of a constellation display showing a succession of corresponding constellation points having a phase rotation due to frequency offset.

FIG. 2 is a graphic view of a constellation display showing the results of rotating the constellation points using a fixed reference vector according to the prior art.

FIG. 3 is a block diagram of a typical receiver for producing discrete-time samples from a modulated GSM RF downlink signal for processing according to the present invention.

FIG. 4 is a graphic view of an ideal constellation display without frequency offset showing the overlay of every fourth symbol.

FIG. 5 is a graphic view of a constellation display showing the results of rotating the constellation points using a delayed signal vector as a reference according to the present invention.

FIG. 6 is a graphic view of a constellation display with frequency offset showing accumulated phase rotation due to the frequency offset.

FIG. 7 is a graphic view of a constellation display showing the phase angles of respective constellation points with frequency offset.

FIG. 8 is a graphic view of a constellation display showing the determination of the phase angle produced by the frequency offset from which the frequency offset is estimated.

### DETAILED DESCRIPTION OF THE INVENTION

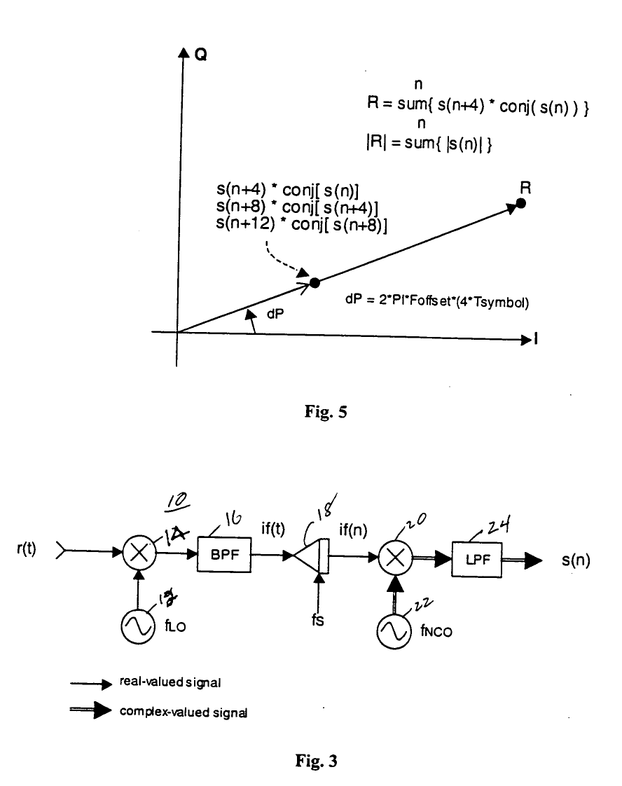

A typical receiver 10 for acquiring discrete-time samples from a modulated GSM RF downlink signal is shown in FIG. 3 where an input signal r(t), having a carrier frequency f_{RF}, is mixed (multiplied) with a local oscillator 12 frequency f_{LO} in a first mixer 14. The resulting frequency-translated signal is filtered by a bandpass filter 16 to produce an IF signal if(t), and then digitized by an analog-to-digital converter (ADC) 18 at a sampling frequency f_{S} to produce a digital data stream if(n). The digitized data stream is mixed in a second mixer 20 with a complex-valued local (digital) oscillator 22 frequency F_{NCO} to produce the final frequency down conversion to baseband (0->f_{RF}). A final lowpass filter 24 rejects signals outside the band of interest, leaving discrete signal samples s(n) at a rate of f_{S} samples per second. These signal samples are then processed by a digital signal processor (DSP) (not shown) as described below. The DSP may be implemented in either hardware or software. The configuration of FIG. 3 is only one of many that may be used to obtain the discrete baseband signal samples s(n).

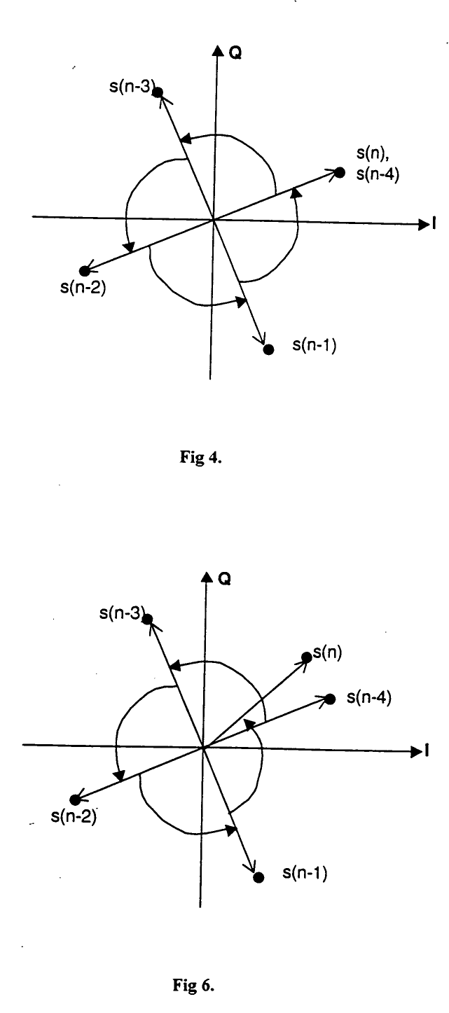

An improvement to the correlation techniques described above is made by using a delayed version of the received signal itself as the reference signal, with the time delay set to, for example, an integer multiple of four times the symbol period. The four symbol delay is chosen because this is the interval that produces exactly one cycle of phase rotation in the FCB signal with no frequency offset, as shown in FIG. 4. The constellation points of an ideal Frequency Control Burst (FCB) signal form a repeating four-point pattern, each constellation point rotated 90 degrees from the previous one, such that every fourth point lands exactly on top of a previous point. The reference signal then becomes:

$$\begin{matrix}r ( n ) = s ( n - 4 * {T}_{symbol} / {T}_{sample} ) \\ = s ( n - 4 * {F}_{sample} / {F}_{symbol} ) \\ = A exp [ j {ω}^{′} / {F}_{sample} * ( n - 4 * {F}_{sample} / {F}_{symbol} ) + φ 0 ) ]\end{matrix}$$

Then the correlation result becomes:

$$\begin{matrix}R = {\sum }_{n = 0 -> N}^{} s ( n ) * conj [ r ( n ) ] \\ = {\sum }_{n = 0 -> N}^{} A exp [ j ( {ω}^{′} / {F}_{sample} * n + φ 0 ) ] * A exp [ - j ( {ω}^{′} / {F}_{sample} * \\ ( n - 4 * {F}_{sample} / {F}_{symbol} ) + φ 0 ) ] \\ = {A}^{2} {\sum }_{n = 0 -> N}^{} exp [ j ( {ω}^{′} / {F}_{sample} * 4 * {F}_{sample} / {F}_{symbol} ) ] \\ = {A}^{2} {\sum }_{n = 0 -> N}^{} exp [ j ( ( 2 π ( {F}_{symbol} / 4 + Foffset ) * 4 / Fsymbol ) ] \\ = {A}^{2} {\sum }_{n = 0 -> N}^{} exp [ j 2 π ( 1 + 4 Foffset / Fsymbol ) ] \\ = {A}^{2} {\sum }_{n = 0 -> N}^{} exp [ j 2 π ] exp [ j 2 π * 4 Foffset / Fsymbol ) ] \\ = {A}^{2} {\sum }_{n = 0 -> N}^{} 1 * exp [ j 8 π * Foffset / Fsymbol ] \\ = {A}^{2} N * exp [ j 8 π * Foffset / Fsymbol ]\end{matrix}$$

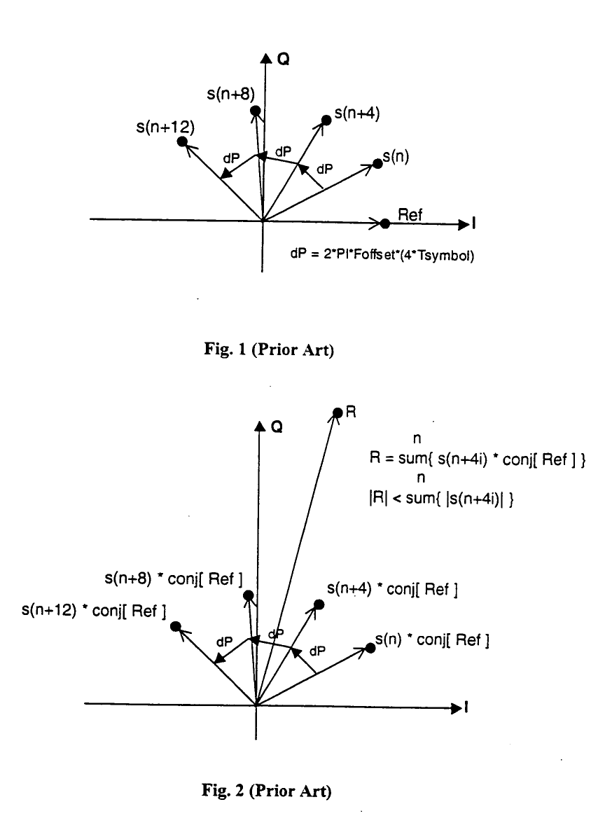

In the last line above the right-hand quantity is a constant for a particular value of F_{offset}, meaning that the correlation magnitude is constant. Therefore the magnitude of the correlation result does not vary as a function of frequency offset. This is illustrated in FIG. 5 where the affect of “rotating” the constellation points from FIG. 1 is shown using the 4^{th} previous (delayed) symbol as the “reference.” This causes the product vectors to all align at the same phase angle dP. Then when the correlation summation R is performed, all the product vectors add constructively since the product vectors have the same phase angle caused by the frequency offset. The magnitude of R is approximately equal to the sum of the magnitudes of the original vectors, i.e., its maximum value, and is not affected by the frequency offset. As explained below the phase angle of R may also be used to compute the frequency offset. So if maximum correlation magnitude is used to detect the FCB signal location, the detection process is insensitive to frequency offset, in contrast to the correlation methods described in the Background above.

The resulting constellation points for the FCB signal are shown in FIG. 6 where F_{offset < >}0. Here the constellation points are slightly off from 90 degree rotations on every symbol interval due to the frequency offset so that the difference in position between every fourth pair of points is the accumulated phase rotation over four symbol periods. The s(n-3) . . . s(n-1) points are in slightly different positions than in FIG. 1, although for illustration FIG. 6 only shows the rotation offset between the s(n) and s(n-4) symbol points.

Although the above derivation uses discrete-time sample points, it may also be derived for the continuous-time case with similar results. The only significant change to the derivation is the replacement of the discrete summations with continuous-time integrations. The conclusion is the same.

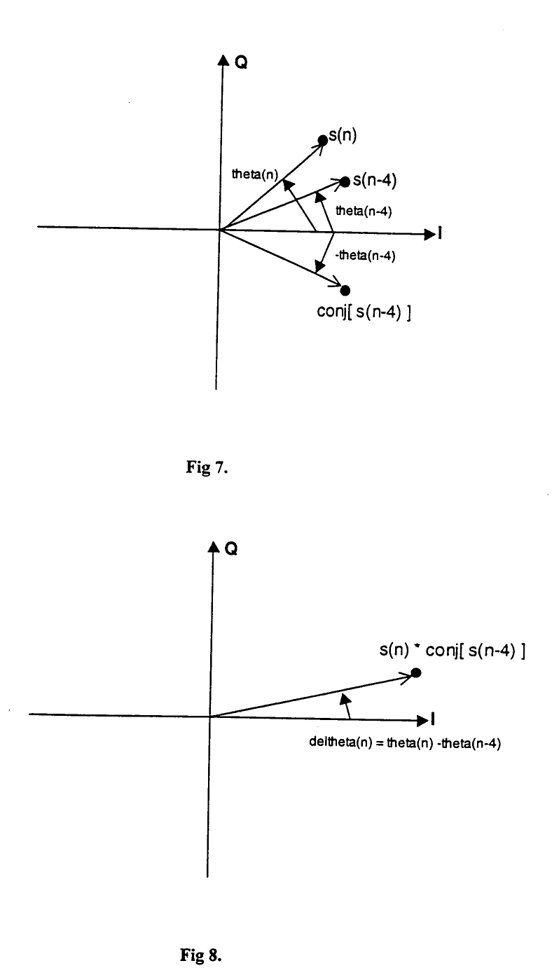

An additional useful property of this result is that the correlation result vector phase angle may be used to estimate the frequency offset. Computing the phase angle of the correlation result R and solving for F_{offset} gives:
F_{offset}=PhaseAngle(R)*F_{symbol}/8π
FIG. 7 shows two constellation points, s(n) and s(n-4), separated by four symbol intervals. If there were no frequency offset, these points would land on top of each other. However with a frequency offset (F_{offset}≦ >0), the later point s(n) is rotated from the earlier point s(n-4) by the phase rotation due to the frequency offset. Phase angles of the respective constellation points are labeled “theta( )”. For a constant frequency offset the amount of phase rotation between any two constellation points separated by equal time intervals, such as the four symbols illustrated, is constant. The phase difference is (theta(n)-theta(n-4)). Also shown is the conjugate version of the “n-4” constellation point. This is a simple way to obtain the -theta(n-4) value for finding the difference in angles when doing the subsequent vector product operation.

FIG. 8 shows the vector product of the two constellation points separated by four symbol intervals. If there were no frequency offset, the product vector points would fall exactly on the real (I) axis no matter what the phase angles of the original constellation points were. With a frequency offset (F_{offset < >}0) the product has a positive or negative phase angle depending upon the sign of the frequency offset. The amount of the product vector phase angle from 0, i.e., from the I-axis, is proportional to the amount of the frequency offset in the carrier signal. This is due to the fact that each succeeding signal point “accumulates” the same amount of additional phase angle due to the frequency offset, no matter where it lands in the constellation diagram. The vector product isolates the “extra” phase rotation due to the frequency offset from the phase rotation due to the normal 90 degree rotation of the signal vector. The “extra” phase rotation is used to estimate the frequency offset.

This method also lends itself to a variation allowing improved computational efficiency, the tradeoff being a slight sensitivity to frequency offset, although much less than the method using an ideal reference. The modification is to accumulate only the real component of the correlation product:

$$\begin{matrix}R = {\sum }_{n = 0 -> N}^{} re \{ s ( n ) * conj [ r ( n ) ] \} \\ = {\sum }_{n = 0 -> N}^{} re \{ [ ( sre ( ) + j sim ( n ) ) * ( sre ( n - 4 * {F}_{sample} / {F}_{symbol} ) - \\ j sim ( n - 4 * {F}_{sample} / {F}_{symbol} ) ) ] \} \\ = {\sum }_{n = 0 -> N}^{} [ sre ( n ) * sre ( n - 4 * {F}_{sample} / {F}_{symbol} ) + sim ( n ) * \\ sim ( n - 4 * {F}_{sample} / {F}_{symbol} ) ]\end{matrix}$$

This modification reduces the number of operations by a factor of two (two multiplications and one addition for each complex product in the correlation summation). These computational savings may allow reduced complexity in the hardware or software DSP implementation of the FCB signal search. The penalty is the reduction in correlation magnitude of 0.04, 0.15, 0.97 and 4.44 dB versus the full complex correlation product summation for frequency offsets of 1000, 2000, 5000 and 10,000 Hz respectively. Therefore the use of this method should be limited to cases where there is good certainty that the frequency offset is within an acceptable range around the nominal. Also since only the real part of the correlation product is computed, the correlation phase angle is not available to directly compute the frequency offset. However once the FCB signal location is detected, it is a simple operation to compute the imaginary portion of the correlation for that location and then obtain the frequency offset from the resulting phase angle.

Thus the present invention provides a method of detecting in a GSM downlink signal a frequency correction burst signal using a correlation magnitude correlation where the signal itself is delayed by an integer multiple of one cycle of rotation of the FCB signal and used as the reference waveform so that the method is insensitive to carrier frequency offset.

1. A method of detecting a frequency correction burst signal in a received signal comprising the steps of:
delaying the received signal by a period that is an integer multiple of one cycle of rotation of the frequency correction burst signal to produce a reference signal; and
correlating the received signal with a conjugate version of the reference signal to produce a correlation result that is insensitive to a frequency offset in a nominal carrier frequency of the received signal, the correlation result being indicative of a location of the frequency correction burst signal within the received signal.

2. The method as recited in claim 1 further comprising the step of estimating the frequency offset as a function of the correlation result.

3. The method as recited in claim 1 wherein the correlating step uses only real components of the received signal for improved computational efficiency where the frequency offset is expected to be within an acceptable range around nominal.

4. The method as recited in claim 3 further comprising the steps of:
determining quadrature components of the received signal at the location of the frequency correction burst signal to determine in conjunction with the real components a phase angle; and
estimating the frequency offset as a function of the phase angle.

5. The method as recited in claim 1 further comprising the step of down-converting the received signal to a baseband complex discrete-time sample signal for input to the delaying and correlating steps as the received signal.

6. The method as recited in claim 5 wherein the down-converting step comprises the steps of:
mixing the received signal with a first local oscillator signal to produce an intermediate frequency signal;
digitizing the intermediate frequency signal to produce a sampled intermediate frequency signal;
mixing the sampled intermediate frequency signal with a second complex local oscillator signal to produce a sample signal with real and quadrature components as the baseband complex discrete-time sample signal.
